(19) United States
(12) Patent Application Publication
(10) Pub. No.: US 2012/0325473 A1
(43) Pub. Date: Dec. 27, 2012

(54) CATALYTIC POLYMER BEAD COMPOSITIONS; PROCESSIING FOR THEIR PRODUCTION; AND THEIR USE IN GENERATING AND EXTRACTING NATURAL GAS, LIGHT CRUDE OIL, OR SEQUENCES OR MIXTURES THEREOF

(75) Inventor: Jozef Bicerano, Midland, MI (US)

(73) Assignee: SUN DRILLING PRODUCTS CORPORATION, Belle Chasse, LA (US)

(21) Appl. No.: 13/577,136

(22) PCT Filed: Mar. 9, 2011
(86) PCT No.: PCT/US11/27735

§ 371 Date: Aug. 3, 2012

Related U.S. Application Data
(60) Provisional application No. 61/314,013, filed on Mar. 15, 2010.

(51) Int. Cl. C09K 8/80; E21B 43/267; C09K 8/62; B82Y 30/00

(52) U.S. Cl. 166/280.2; 507/219; 507/231; 977/773

(57) ABSTRACT

In one aspect, this invention provides a method for the in-situ production of natural gas, light crude oil, or sequences or mixtures thereof, comprising the steps of: (a) suspending a catalytic polymer bead in a fracturing medium, wherein said catalytic polymer bead is nearly neutrally buoyant in said fracturing medium; (b) introducing said suspension into a formation at sufficiently high rates and pressures that the formation fails and fractures to accept said suspension; and (c) collecting the natural gas, light crude oil, or sequences or mixtures thereof, generated by the subterranean formation. In another aspect, this invention provides compositions of matter for said catalytic polymer beads. In yet another aspect, this invention provides processing methods for producing said catalytic polymer beads.

This application claims the benefit of U.S. Provisional Application No. 61/314,013 filed Mar. 15, 2010.

### FIELD OF THE INVENTION

The present invention relates to catalytic polymer bead compositions, methods for the production of such beads, and the use of such beads in natural gas generation and extraction. The present invention also relates to the use of such beads for breaking down a heavy crude oil in a hydrocarbon reservoir to produce a light crude oil from the reservoir. The bead compositions of the invention include a polymeric substrate, and a coating placed on the substrate, wherein the coating includes a transition metal compound.

### BACKGROUND

Historically, the thermal cracking of heavier hydrocarbons and biogenesis have been assumed to be the main mechanisms for the generation of natural gas in hydrocarbon reservoirs over geological time scales (typically expressed in units of millions of years). Recent research has, however, shown that catalytic mechanisms induced by transition metals may also play an important role in natural gas generation by hydrocarbon reservoirs. These research findings have raised questions in the exploration and production industry about whether it may be possible to modify some of the conventional formulations and processes for the stimulated production of hydrocarbons from a reservoir to enhance natural gas production via catalytic mechanisms.

Fossil fuel resources have been generated in our planet's crust via slow processes that took place over geological time scales measured in units of millions of years. They are present at finite amounts. They have been dwindling since the 19^{th} century when increasingly sophisticated technology began to become available both to extract them and to use them. The high standard of living enjoyed throughout much of the world, unprecedented in the long history of the human species, has been made possible mainly by the ability to extract and to use fossil fuel resources. However, since fossil fuel resources cannot be replenished by geological processes nearly as fast as they are being used by humans, their depletion is inevitable, as described often in terms of the concept of “peak oil”. If their depletion rate continues to outpace the rate of development of inexpensive and abundant alternative energy resources, human civilization will inevitably suffer a major setback when fossil fuel resources become scarce and very expensive while inexpensive and abundant alternatives are not available yet. If it were to become possible to enhance natural gas production via catalytic mechanisms, this development would have a major immediate industrial impact. Furthermore, it would add many years to the amount of time that remains for the development of inexpensive and abundant alternative energy resources, making the inevitable transition from a fossil-fuel-based human civilization to an alternative-energy-based human civilization much smoother and less painful.

### SUMMARY OF THE INVENTION

Catalytic polymer bead compositions, methods for their production, and their use in natural gas generation and extraction as some of their possible applications, are disclosed. The catalytic polymer bead compositions of the invention include a polymeric substrate, and a coating placed on the substrate, the coating including a transition metal compound and the catalytic polymer bead compositions possessing a specific gravity ranging from 1.00 to 1.25. In some embodiments, the catalytic polymer bead is substantially spherical in shape. In some embodiments, the polymeric substrate is a terpolymer of styrene, ethylvinylbenzene, and divinylbenzene.

In some embodiments, the polymeric substrate may further include nanofiller particles possessing a length that is less than 500 nanometers in at least one principal axis direction dispersed throughout the polymer substrate. In yet other embodiments, the substrate further includes an impact modifier material. In still yet other embodiments, the substrate further includes a dispersed filler, a coating, or a combination thereof, where in the dispersed filler is selected from the group consisting of a ferroelectric material, a giant magnetostrictive material, or a mixture thereof.

The catalytic polymer bead compositions include a transition metal compound which may be placed as a coating on the substrate, embedded in a polymeric coating that may be placed on the substrate, or a combination thereof. The transition metal compound includes nickel, iron, cobalt, titanium, vanadium, chromium, zirconium, tungsten, rhenium, ruthenium, molybdenum, hafnium, tantalum, osmium, iridium, platinum, palladium, or a mixture thereof. In some embodiments, the transition metal compound includes a metal nanocluster, metal halide, metal oxide, metal hydride, metal porphyrin, metal ester, metal phosphine, metal aminophosphine, metallocene, Ziegler-Natta catalyst, Grubbs catalyst, Schrock catalyst, or mixture thereof.

In some embodiments, the catalytic polymer bead may be used in natural gas generation and extraction. During fracture stimulation, the catalytic polymer beads are placed in a subterranean environment wherein they accelerate the catalytic generation of natural gas by introducing transition metals in quantities that far exceed their natural concentrations therein. The catalytic polymer beads may also help to keep a fracture open by resisting the closure stress applied by the geological formation above the fracture.

The applications of such catalytic polymer beads include, but are not limited to, in-situ natural gas formation in a subterranean environment of a hydrocarbon reservoir. Activation of a transition metal transported into the environment on the beads results in a catalytic production of natural gas by the reservoir. Some non-limiting implementations of the invention may accelerate natural gas production to such an extent that it takes place within a time scale of cost-effective commercial production rather than taking place over millions of years. Furthermore, in some non-limiting implementations of the invention, the beads may also help to keep a fracture open by resisting the closure stress applied by the geological formation above a fracture.

In such embodiments, the main limitation on the thickness of a coating is related to the constraints imposed by the targeted specific gravity range of 1.00 to 1.25 for the catalytic polymer beads. A transition metal compound will generally have a higher specific gravity than a polymeric substrate so that the specific gravity of a catalytic polymer bead will generally increase with increasing thickness of a coating. Hence, the lower the specific gravity of the polymeric substrate, the thicker a given coating can be on it; and the lower the specific gravity of the coating material, the thicker its coating can be on a given polymeric substrate; before the specific gravity of the catalytic polymer bead reaches 1.25 in most embodiments of the invention. As will be illustrated later with some examples, the maximum thickness of the coating in such embodiments also depends on geometrical factors. For example, if a polymeric substrate is in the shape of a spherical bead, then the maximum thickness of a given coating material that can be placed on it before the specific gravity of the catalytic polymer bead reaches 1.25 increases with increasing diameter of the spherical polymeric substrate.

In some other embodiments, such as but not limited to embodiments where a transition metal compound is dispersed at a low concentration in a polymeric coating material of low specific gravity, the total coating material (including both the polymeric coating material and the transition metal compound dispersed therein) may have a lower specific gravity than the polymeric substrate. In such embodiments, the maximum targeted specific gravity of 1.25 for the catalytic polymer bead would not impose any limitation on the maximum coating thickness.

The surprising discovery that catalytic polymer beads including coatings including transition metal compounds can greatly accelerate natural gas generation has major implications in terms of the continued availability and abundance of relatively inexpensive natural gas for the benefit of humankind. For example, many hydrocarbon-rich geological formations that currently have zero or very low productivity of natural gas may, with the help of the catalytic polymer beads of the invention, be made to yield natural gas with commercially viable productivities.

While the catalytic polymer bead compositions of the invention were developed with natural gas generation and extraction as an application of special interest, such beads can also be used in many other applications by tailoring embodiments of the invention to meet the performance needs of the applications. A non-limiting example of an alternative application is the breaking down of a heavy crude oil in a hydrocarbon reservoir to produce a light crude oil from the reservoir.

Selected embodiments will be described in greater detail in the following section which is intended to provide a better understanding of the invention by providing some illustrative examples without limiting the full scope of the invention.

### BRIEF DESCRIPTION OF THE DRAWINGS

The accompanying drawings, which are included to provide further understanding of the invention and are incorporated in and constitute a part of this specification, illustrate non-limiting embodiments of the invention and, together with the description, serve to explain the principles of the invention.

FIG. 1 shows the calculated thickness of a coating whose specific gravity (SG) is 2.0, when it is placed on a spherical substrate (uncoated bead) whose specific gravity is 1.054 at a sufficient thickness that the coated bead specific gravities attain the values shown in the curve labels, as a function of the U.S. mesh size (a) and the diameter (b) of the spherical substrate.

FIG. 2 shows the calculated specific gravity of a coated spherical bead obtained by placing a coating whose specific gravity (SG) is 2.0 on a spherical substrate (uncoated bead) whose specific gravity is 1.054 at the thicknesses shown in the curve labels, as a function of the U.S. mesh size (a) and the diameter (b) of the spherical substrate.

### DETAILED DESCRIPTION

The present invention provides for catalytic polymer bead compositions including a polymeric substrate, and a coating placed on the substrate, wherein the coating includes a transition metal compound and the catalytic polymer bead compositions possessing a specific gravity ranging from 1.00 to 1.25. In some embodiments, the catalytic polymer beads have sizes ranging from 0.177 mm (80 U.S. standard mesh size) to 1.41 mm (14 U.S. standard mesh size) and possess a specific gravity ranging from 1.00 to 1.25. In some other embodiments, the catalytic polymer beads have sizes ranging from 0.177 mm (80 U.S. standard mesh size) to 0.595 mm (30 U.S. standard mesh size) and possess a specific gravity ranging from: 1.00 to 1.4; and 1.00 to 1.08. In still yet other embodiments, the catalytic polymer beads have sizes ranging from 0.42 mm (40 U.S. standard mesh size) to 1.41 mm (14 U.S. standard mesh size) and possess a specific gravity ranging from 1.00 to 1.08. The methods of use, described herein below, will determine the size range and specific gravity range of the catalytic polymer bead.

### A. Substrate Materials Used in Catalytic Polymer Beads

Any suitable polymeric material, possessing a specific gravity in the range of 1.00 to 1.11, may be used as a substrate in the catalytic polymer bead compositions of the invention. In some embodiments, the polymer substrate may be a spherical bead having a diameter which does not exceed 10 millimeters. In some other embodiments, the polymer substrate may be a spherical bead having a diameter ranging from 0.1 mm to 4 mm. In some other embodiments, the polymer substrate may be a spherical bead having a diameter ranging from: 0.177 mm to 1.41 mm; 0.177 to 0.595 mm; and 0.42 mm to 1.41 mm. In some embodiments, the polymeric substrate may be non-porous. In some embodiments, the substrate material may be a thermoset polymer. In some other embodiments, the substrate material may be a rigid thermoset polymer.

Rigid thermoset polymers, which may be used as the polymeric substrate material of the present invention, are amorphous polymers where covalent cross-linking bonds provide a three-dimensional network. However, unlike thermoset elastomers (often referred to as “rubbers”) which also possess a three-dimensional network of covalent crosslinks, the rigid thermoset polymers are, by definition, “stiff”. In other words, rigid thermoset polymers have high elastic moduli at “room temperature” (25° C.), and often up to much higher temperatures, because their combinations of chain segment stiffness and crosslink density result in a high glass transition temperature. In one embodiment, rigid thermoset polymers may include crosslinked epoxies, epoxy vinyl esters, polyesters, phenolics, melamine-based resins, polyimides, polyurethanes, and polyureas. In one such embodiment, the rigid thermoset polymer is non-porous. In another embodiment, the rigid thermoset polymer may include members of various families of crosslinked copolymers prepared most often by the polymerization of vinylic monomers, of vinylidene monomers, or of mixtures. In one such embodiment, the rigid thermoset polymer may be non-porous. Crosslinked styrenics and crosslinked acrylics are familiar examples of families of rigid thermoset polymers built from vinylic monomers. Rigid thermoset polymers based on vinylic monomers are typically prepared by the reaction of a mixture containing one or more non-crosslinking monomer and one or more crosslinking monomers. For example, in one embodiment, the rigid thermoset polymer may include a terpolymer of styrene (St, non-crosslinking), ethylvinylbenzene (EVB, non-crosslinking), and divinylbenzene (DVB, crosslinking). Such a terpolymer may be non-porous. In one such embodiment, the terpolymer may be prepared via suspension polymerization. In some embodiments, the extent of crosslinking in the rigid thermoset polymers can be adjusted by varying the percentage of a crosslinker (such as, but not limited to, DVB) in its reactive precursor mixture, post-synthesis curing of the rigid thermoset polymer via heat treatment, or a combination thereof as described in U.S. Application Publ. No. 20070021309. For example, in some terpolymers of St, EVB, and DVB, the extent of crosslinking is adjusted by (a) using DVB at an amount selected from the range of 3% to 35% by weight in the mixture of reactive monomers (St, EVB, and DVB), and (b) choosing between the use of the “as polymerized” product emerging from the polymerization reactor or postcuring via heat treatment to obtain additional crosslinking.

In some non-limiting embodiments, the substrate material may be a nanocomposite, including nanofillers dispersed in a matrix of the polymeric substrate, various embodiments of which are discussed above. A “nanofiller” is defined in this disclosure as a particle of any shape possessing a length that is less than 500 nanometers in at least one principal axis direction. Such nanocomposite compositions may contain nanofillers in the amount ranging from: 0.001 to 0.5 vol. %; 0.01 to 0.5 vol. %; 0.1 to 0.5 vol. %; 0.1 to 1.0 vol. %; 0.1 to 5 vol. %; 1 to 5 vol. %; and 1 to 10 vol. %. In such embodiments, the nanofillers may include carbon black, fumed silica, fumed alumina, carbon nanotubes, carbon nanofibers, cellulosic nanofibers, natural clays, synthetic clays, fly ash, polyhedral oligomeric silsesquioxanes or mixtures thereof. In one embodiment, the nanofiller may be carbon black in an amount ranging from: 0.01 to 1 vol. %; or 0.01 to 0.5 vol. % as described in U.S. Application Publ. No. 20070066491; and in U.S. Pat. Nos. 7,803,740, 7,803,741, and 7,803,742. In one embodiment, the nanocomposite composition may include a terpolymer of styrene (S), ethylvinylbenzene (EVB) and divinylbenzene (DVB) in combination with carbon black at concentrations of 0.01 to 1 vol. %; or 0.01 to 0.5 vol. %.

In some other embodiments, the polymeric substrate material, various embodiments of which are discussed above, may include an impact modifier as described in U.S. Application Publ. No. 20070161515. The impact modifier may include at least one of a monomer, oligomer or polymer including polybutadiene (including its solid and liquid forms, and any of its variants including different cis-1,4, trans-1,4, and vinyl-1,2 isomer contents), natural rubber, synthetic polyisoprene, polychloroprene, nitrile rubbers, other diene rubbers, partially or completely hydrogenated versions of any of the diene rubbers, acrylic rubbers, olefinic rubbers, epichlorohydrin rubbers, fluorocarbon rubbers, fluorosilicon rubbers, block and/or graft copolymers prepared from formulations including styrenic monomers and diene monomers, partially or completely hydrogenated versions of block and/or graft copolymers prepared from formulations including styrenic monomers and diene monomers, silicone rubbers, rubbers containing aliphatic or partially aromatic polyether chain segments, rubbers containing aliphatic or partially aromatic polyester chain segments, rubbers containing aliphatic or partially aromatic polyurethane chain segments, rubbers containing aliphatic or partially aromatic polyurea chain segments, rubbers containing aliphatic or partially aromatic polyamide chain segments, ionomer resins which may be partially or wholly be neutralized with counterions; other rubbery homopolymers, copolymers containing random, block, graft, star, or core-shell morphologies, and mixtures thereof; and the monomeric or oligomeric precursors of any of the cited types of rubbery polymers. For example, in many non-limiting embodiments, the impact modifier may include a methacrylate-butadiene-styrene (MBS) core-shell copolymer, a styrene-butadiene-styrene (SBS) triblock copolymer, a styrene-butadiene (SB) diblock copolymer, a polybutadiene (PBD), or a mixture thereof.

In some embodiments, some of the St, EVB and/or DVB monomers used in the reactive precursor mixture of the polymeric substrate material may be replaced by reactive ingredients obtained and/or derived from renewable resources such as vegetable oils and/or animal fats (U.S. Application Publ. No. 20070181302).

In some embodiments, the polymeric substrate material may include a dispersed filler, as described in U.S. Application Publ. No. 20090250216, or/and a coating, as described in U.S. Application Publ. No. 20100038083. The dispersed filler possesses electromagnetic properties which change at a detectable level under a mechanical stress such as a closure stress of a fracture in order to allow the substrate material to be tracked and monitored in a downhole environment. In some embodiments, the dispersed filler may be a ferroelectric material. In such embodiments, the ferroelectric material may include lead zirconate titanate (PZT), barium titanate, or a mixture thereof. In some embodiments, the dispersed filler may be a giant magnetostrictive material. In such embodiments, the giant magnetostrictive material may include a terbium-dysprosium-iron alloy (Terfenol-D), a gallium-iron alloy (Galfenol), a samarium-dysprosium-iron alloy (Samfenol-D), or a mixture thereof. Such materials tend to have a much higher specific gravity as well as a much higher cost than the polymeric matrix of a polymeric substrate material in which they may be dispersed. For example, a typical polymeric substrate material not containing any dispersed additives of these types may have a specific gravity in the range of 1.00 to 1.11. On the other hand, a typical Terfenol-D alloy may have a specific gravity of around 9.2, a typical PZT alloy may have a specific gravity of around 7.6, and barium titanate has a specific gravity of around 6. Consequently, the amount dispersed in a specific embodiment tends to be a compromise between the simultaneously occurring desirable increase of the detectable electromagnetic effects and undesirable increases of specific gravity and cost as the dispersed amount is increased. The maximum amount of such dispersed fillers, incorporated in many non-limiting embodiments, does not exceed 5% by volume of the polymeric substrate because of these conflicting desirable and undesirable effects of the additive. In other embodiments, amount of dispersed filler ranges from 0.001 to 5 vol. %.

U.S. Application Publ. Nos. 20070021309, 20070066491, 20070161515, 20070181302, 20090250216 and 20100038083; and U.S. Pat. Nos. 7,803,740, 7,803,741, and 7,803,742; are each incorporated herein in its entirety by reference.

The various embodiments of the polymeric substrate described above should possess sufficient compressive strength or structural integrity to withstand the high closure stresses and temperatures of hydrocarbon reservoirs. In some embodiments, the polymeric substrate may have a crush resistance of greater than 40 MPa. In other embodiments, the polymeric substrate may have a crush resistance of greater than 55 MPa. In yet some other embodiments, the catalytic polymer beads may have a crush resistance of greater than 70 MPa. In such embodiments, crush resistance may be determined according to International Standard ISO 13503-2:2006, “Petroleum and Natural Gas Industries—Completion Fluids and Materials—Part 2: Measurement of Properties of Proppants Used in Hydraulic Fracturing and Gravel-Packing Operations” (2006), Section 11.

In other embodiments, the compressive strength or structural integrity of the polymeric substrate may be measured according to its conductivity as described below. It is a common practice in the industry to use the simulated environment of a hydrocarbon reservoir in evaluating the conductivities of packings of particles. The API RP 61 method, described by a publication of the American Petroleum Institute titled “Recommended Practices for Evaluating Short Term Proppant Pack Conductivity” (1989); and International Standard ISO 13503-5:2006, “Petroleum and Natural Gas Industries—Completion Fluids and Materials—Part 5: Procedures for Measuring the Long-term Conductivity of Proppants” (2006), are examples of frequently used standards for conductivity testing in the simulated environment of a hydrocarbon reservoir. In some embodiments, a packing of beads of a polymeric substrate manifests a conductivity of at least 100 mDft after 300 hours under a closure stress of at least 6000 psi at a temperature of at least 250° F. In some other embodiments, a packing of beads of a substrate material manifests a conductivity of at least 100 mDft after 300 hours under a closure stress of at least 8000 psi at a temperature of at least 250° F. In yet some other embodiments, a packing of beads of a substrate material manifests a conductivity of at least 100 mDft after 300 hours under a closure stress of at least 8000 psi at a temperature of at least 275° F. Either a conventional multilayer “packed mass” or a partial monolayer of beads of a polymeric substrate may be used in verifying that an embodiment meets these criteria for manifesting a conductivity of at least 100 mDft after 300 hours at the specified combinations of temperature and closure stress.

### B. Coating Materials Used in Catalytic Polymer Beads

### 1. General Approaches

In some embodiments of the invention, a transition metal compound, or a mixture or combination thereof, may be placed upon a polymeric substrate, including the various embodiments discussed in Part A herein, via one or a combination of three types of approaches, to thereby form the catalytic polymer beads of the present invention. In some embodiments, the transition metal compound may exist as a cluster or nanocluster of pure transition metal atoms. In other embodiments, the transition metal compound may exist as a particle or nanoparticle of a transition metal compound.

In one approach, a transition metal compound may be placed as a coating on a polymeric substrate, to impart catalytic activity to at least part or substantially the entire surface of the substrate which in some embodiments may possess the shape of a spherical bead. For example, a transition metal compound may cover all or a portion of the surface of a polymeric substrate in some non-limiting embodiments. In some other non-limiting embodiments, a transition metal compound may become embedded at the surface of the polymeric substrate as discrete catalytically active regions without covering either all or even a portion of the surface as a layer. Most non-limiting embodiments based on this approach fall into two broad classes and mixtures thereof: (a) In some embodiments, the adhesion between a polymeric substrate and a transition metal compound coating is strong enough for the coating to remain on the polymeric substrate during use in a subterranean environment. The transition metal compound is hence immobilized and substantially remains at locations where the catalytic polymer beads have been pinned down by the closure stress of a geological formation after transport and emplacement therein. (b) In some other embodiments, the adhesion between a polymeric substrate and a transition metal compound coating is barely strong enough for the coating to remain substantially intact during transport to a subterranean environment where it becomes partially or completely detached from the polymeric substrate over time. In such an embodiment, a polymeric substrate serves mainly as a carrier for a transition metal compound. Depending upon the conditions prevailing in a specific subterranean environment, such an embodiment may be advantageous by allowing the exposed catalytically active surface area to increase (potentially by more than an order of magnitude) over time, or disadvantageous as a result of detached particles of a transition metal compound being carried away from a fracture by gas and/or liquid flow. Many analytical techniques are available for evaluating the extent to which a coating may be affected by transport to a subterranean environment. If it is possible to recover some of the catalytic polymer beads from the subterranean environment, such recovered beads can be compared with unused beads to assess the effect, if any, of the transport process to the coatings on the beads. However, it is usually more feasible and cost-effective from a practical standpoint to compare unused beads with beads that have been subjected under controlled laboratory conditions to environments (such as immersion in the carrier fluid of interest) and physical conditions (such as temperature, pressure, and flow rate) similar to those that are likely to be encountered during transport. The most useful analytical technique or combinations of techniques to use in such comparisons depend on the details of the composition and the thickness of the coating. The analytical techniques available for making such comparisons include, but are not limited to, optical microscopy, scanning electron microscopy, transmission electron microscopy, Auger electron spectroscopy (AES), x-ray photoelectron spectroscopy, time-of-flight secondary ion mass spectrometry (TOF-SIMS), dynamic secondary ion mass spectrometry (D-SIMS), energy dispersive analysis (EDA), electron energy loss spectroscopy (EELS), gas chromatography coupled with mass spectroscopy (GC-MS), surface topography analysis, and combinations or sequences thereof.

In another approach, a transition metal compound may be embedded in a polymeric coating (referred to as a “binder” by some workers in the field of the invention) placed on the external surface of a polymeric substrate. In some such embodiments, some amount of the transition metal compound may be located at an outer surface of the coating and thus be exposed to an external environment. Any suitable polymeric coating material, including but not limited to epoxies, epoxy vinyl esters, polyesters, acrylics, phenolics, alkyd resins, melamine-based resins, furfuryl alcohol resins, polyacetals, polyurethanes, polyureas, polyimides, polyxylylenes, silicones, fluoropoly ers, copolymers thereof, or combinations thereof, may be used. For example, epoxies are used as polymeric coating materials in some non-limiting embodiments, and phenolics are used as polymeric coating materials in some other non-limiting embodiments. This approach may provide stronger adhesion of a transition metal compound to a polymeric substrate surface as compared with coating the transition metal compound directly onto a polymeric substrate. In some such embodiments, a transition metal compound is immobilized onto the polymeric substrate and substantially remains at locations where the catalytic polymer beads have been pinned down by the closure stress of a geological formation after transport and emplacement therein. This approach may sometimes provide the advantages of smaller increases of both the specific gravity and the cost of a catalytic polymer bead relative to its substrate as a result of the use of a smaller amount of a transition metal compound that is often both denser and more expensive than both the polymeric substrate and the polymeric coating material.

In yet another approach, a transition metal compound may be embedded in a polymeric coating placed on the external surface of a polymeric substrate, but with the adhesion between the polymeric substrate and the polymeric coating being barely strong enough for the coating to remain on the polymeric substrate during transport to a subterranean environment where it becomes partially or completely detached from the polymeric substrate over time. In a variant of this approach, the polymeric coating itself may only be strong and durable enough to survive transport to a subterranean environment where it disintegrates upon exposure to the environment (rather than merely becoming detached from the substrate). Depending upon the conditions prevailing in a specific subterranean environment, such an embodiment may be advantageous by allowing the exposed catalytically active surface area to increase (potentially by more than an order of magnitude) over time, or disadvantageous as a result of detached particles of a transition metal compound being carried away from a fracture by gas and/or liquid flow.

### 2. Exemplary Transition Metal Compounds

In the past, the term “transition metal” referred to any element in the d-block of the periodic table, which includes groups 3 to 12 on the periodic table. The modern International Union of Pure and Applied Chemistry (IUPAC) definition (IUPAC, Compendium of Chemical Terminology, Internet Edition, the definition of the term “transition element” was located at the IUPAC website) on the date of this disclosure is more restrictive since it states that a transition metal is “an element whose atom has an incomplete d sub-shell, or which can give rise to cations with an incomplete d sub-shell.” Group 12 elements are not transition metals according this modern IUPAC definition which will be adopted in this disclosure.

A “transition metal compound” will be defined in this disclosure to be a compound, including two or more atoms, among which at least one atom is a transition metal atom. As non-limiting examples intended to clarify the meaning of this definition, (a) a transition metal oxide (such as a nickel oxide) is a transition metal compound formed by atoms of a transition metal (Ni) and of oxygen (O), and (b) a transition metal (such as nickel) nanocluster is a transition metal compound formed by an assembly of atoms of a transition metal (Ni).

A coating of a material that manifests catalytic action and/or is capable of manifesting catalytic action upon activation in an application environment may be placed on the polymeric substrate to enable the use of the catalytic polymer bead as a catalyst in applications discussed herein. Such coatings include transition metal compounds. Many transition metal compounds manifest varying levels of catalytic activity for chemical reactions that result in the cleavage, formation, and/or rearrangements of covalent bonds between the carbon atoms in hydrocarbons. A catalytic and/or activatable coating placed on a polymeric substrate in an implementation of the invention may include any suitable transition metal compound or a mixture or a combination thereof.

Various transition metals differ in the strengths of their catalytic activities. Furthermore; various compounds of a given transition metal differ in the ease with which their catalytic action can be activated, in their commercial availability and cost, and in the ease with which they may be incorporated into a coating. The paragraphs below describe embodiments of transition metal compounds and some general considerations that may help in selecting transition metal compounds to use in the catalytically active coatings of specific embodiments.

In some embodiments, the transition metal may be in the form of a nanocluster. In some such embodiments, the transition metal nanoclusters may possess very high catalytic activity but may need to be protected carefully from oxidation during handling, storage and transport. In other embodiments, nanoclusters of transition metal compounds may be used. It is often substantially easier from a practical standpoint to use a nanocluster of a compound of a transition metal element rather than using a nanocluster of the transition metal element itself to avoid problems associated with oxidation.

Exemplary transition metals may include nickel (Ni), iron (Fe), cobalt (Co), titanium (Ti), vanadium (V), chromium (Cr), zirconium (Zr), tungsten (W), rhenium (Re), ruthenium (Ru), molybdenum (Mo), hafnium (Hf), tantalum (Ta), osmium (Os), iridium (Ir), platinum (Pt), palladium (Pd), and mixtures thereof, as these metals are among the transition metals that are known to manifest catalytic activity in hydrocarbon reactions. Many non-limiting embodiments are possible by using transition metal compounds that include one or a combination of these transition metals. The criteria used in making optimum choices among these transition metals include the extent of their catalytic activity, their availability and cost, and the specific gravities of their compounds. For example, Ni is used in some non-limiting embodiments, Ru is used in some other non-limiting embodiments, and Os is used in yet some other non-limiting embodiments. The catalytic activities, and as of the date of this disclosure also the costs, of these three transition metals vary in the same order (Os>Ru>Ni).

In other embodiments, some compounds of these transition metals can be activated readily, especially in a reducing environment, to enable them to provide catalytic action. Transition metal compounds that may be used include, but are not limited to, a halide (such as, but not limited to, a chloride), an oxide, a hydride (such as, but not limited to, an interstitial binary hydride such as palladium hydride where molecular and/or atomic hydrogen is trapped within a metal lattice), a Ziegler-Natta catalyst, a metallocene [defined as a compound with the general formula (C₅H₅)₂M; such as, but not limited to, ferrocene where M=Fe], a transition metal porphyrin (such as, but not limited to, nickel etioporphyrin or vanadyl etioporphyrin), a transition metal ester (such as, but not limited to, an acetylacetonate or an acetate of nickel, iron, vanadium, cobalt, chromium, manganese, ruthenium, or osmium), a transition metal phosphine, a transition metal aminophosphine, a compound (such as, but not limited to, a Grubbs catalyst or a Schrock catalyst) that can catalyze an olefin metathesis reaction, or a mixture thereof. For example, a halide is used in some non-limiting embodiments, an acetate is used in some other non-limiting embodiments, and an oxide is used in yet some other non-limiting embodiments. Specific examples of such non-limiting embodiments include the use of a chloride, a chloride hydrate, an acetate, an acetate hydrate, or an oxide of Ni, Ru, or Os, or a mixture thereof, as the transition metal compound.

### 3. Activation of Transition Metal Compounds

A factor in selecting a transition metal compound is the ease with which the compound can be activated. Catalytic activity is generally manifested when a transition metal is in a zero-valent state. There are many methods for placing a zero-valent transition metal into a subterranean environment. The following are some non-limiting examples.

In one embodiment, a transition metal may be in a zero-valent state in a selected compound (such as a metal nanocluster) and thus may be ready to manifest its catalytic activity.

In another embodiment, a transition metal may be in an oxidation state differing from zero when deposited upon a substrate and may be reduced to a zero-valent state by an additional fabrication step prior to the placement of a catalytic polymer bead into a subterranean environment. In such implementations, an important consideration is the minimum temperature required to reduce a transition metal in a particular compound to its zero-valent state at an economically acceptable rate for commercial production. For example, a much lower temperature is often sufficient to reduce nickel to its zero-valent state in a nickel porphyrin or in a nickel ester than in NiO. The acceptably rapid reduction of a transition metal to its zero-valent state will preferably take place at a temperature that is low enough not to cause serious damage to a polymeric substrate used in a catalytic polymer bead. In this context, (a) the avoidance of serious damage means that a packing of the catalytic polymer beads manifests a conductivity, after 300 hours, that is at least 80% of the conductivity of a packing of beads of the polymeric substrate material measured, after 300 hours under a set of comparable test conditions; and (b) the use of comparable test conditions means the use of a comparable surface coverage by beads of comparable U.S. mesh size in a packing used in a test cell, and the use of substantially the same closure stress, temperature, and type of test fluid during the tests.

A transition metal may be in an oxidation state differing from zero when deposited upon a polymeric substrate and may become reduced to a zero-valent state “in situ” after the placement of a catalytic polymer bead into a subterranean environment by interacting therein with a reducing (such as hydrogen-comprising) environment at an elevated temperature. In such implementations as well, an important consideration is the minimum temperature required to reduce a transition metal in a particular transition metal compound to its zero-valent state at an economically acceptable rate for commercial production.

Finally, it is also possible to use any combination of the three general types of approaches that were summarized in the paragraphs above.

### 4. Effects of Ligands Attached to a Transition Metal Element

Another factor that is sometimes considered in selecting a transition metal compound is the manner in which and/or the extent to which the ligands associated with the transition metal may affect the catalytic activity of the transition metal. In coordination chemistry, a ligand is an ion, a molecule, or a functional group that binds to a central metal atom to form a coordination complex. The selection of ligands may, for example, affect the catalytic activity of a transition metal by limiting its accessibility to reactive molecular species. The environment of a transition metal (for example, whether it is surrounded just by other transition metal atoms as in a metal nanocluster, or by oxygen atoms as in an oxide, or by porphyrin rings, or by acetylacetonate groups, or by phosphine groups, or by aminophosphine groups, or by cyclopentadienyl rings) can have a huge “steric” effect on the chemical reactions being catalyzed by the transition metal. For example, two Ni compounds containing the same Ni weight fraction may differ greatly in their catalytic activities depending on the ligands attached to the Ni atoms.

In addition to affecting the magnitude of the catalytic activity, the choices of transition metal and of ligand may affect the product distribution, defined as the relative abundances of decomposition products of lower molecular weight. For example, various linear, branched, and cyclic hydrocarbons, each containing six or seven carbon atoms, may be formed at different relative abundances as a hydrocarbon of larger molecular weight is broken down catalytically.

### 5. Starting Hydrocarbon May Also Affect Choice of Transition Metal Compound

The magnitude of the catalytic activity of a transition metal compound and/or the product distribution obtained by using the transition metal compound may be affected by the composition and/or the physical properties of a starting hydrocarbon material of high molecular weight that needs to be decomposed. The “free volume” of a hydrocarbon, defined as the difference between its measured volume and its molecular volume, is a non-limiting example of a physical factor that may play an important role in determining the catalytic decomposition rate and/or the product distribution. Consequently, details related to the composition and the physical properties of a hydrocarbon in a specific reservoir may sometimes need to be considered in order to make an optimum selection of transition metal compound for use in a catalytic polymer bead.

### C. Geometrical and Physical Attributes of Coating Materials Used in Catalytic Polymer Beads

Without limiting the scope of the invention, one often important consideration is that the use of a transition metal compound as a powder in which more than 50% of the particles exceed dimensions of greater than one micron in all three principal axis dimensions, as a pellet, or in a bulk form, may present technical difficulties to the placement of a transition metal coating onto the exterior surface of a polymeric substrate. When starting with such forms and/or dimensions of the transition metal compound, the use of a melt processing technique may be required to melt such compound in order to be able to place it as a coating or to embed it in a coating, but many useful transition metal compounds melt at temperatures far exceeding the thermal decomposition temperatures of selected substrate materials.

In some non-limiting embodiments, a “fine powder” of a transition metal compound, defined for the purposes of this disclosure as a powder in which more than 50% of the particles have dimensions of less than 400 nanometers in all three principal axis directions, is used to enable the placement of a transition metal coating, of a certain thickness, onto the exterior surface of the polymeric substrate.

In some other non-limiting embodiments, a “very fine powder” of a transition metal compound, defined for the purposes of this disclosure as a powder in which more than 50% of the particles have dimensions of less than 100 nanometers in all three principal axis directions, is used to enable the placement of an even thinner coating and/or a thin coating of even more uniform thickness, onto the exterior surface of the polymeric substrate, than is possible by starting from a fine powder.

In yet some other non-limiting embodiments, an “ultrafine powder” of a transition metal compound, defined for the purposes of this disclosure as a powder in which more than 50% of the particles have dimensions of less than 25 nanometers in all three principal axis directions, is used to enable the placement of a yet even thinner coating and/or a thin coating of yet even more uniform thickness, onto the exterior surface of the polymeric substrate, than is possible by starting from a very fine powder.

### D. Coating Methods Used To Form Catalytic Polymer Beads

A coating of the transition metal compound may be placed on the polymeric substrate during a polymerization process that is being used to manufacture the polymeric substrate, after the polymerization process has been completed, or a combination thereof, by using any suitable method for coating a polymeric substrate.

In some embodiments, a preformed polymeric substrate may be coated by using coating methods that include, but are not limited to, (a) sol-gel methods, (b) electrophoretic deposition, (c) fluidized bed coating, (d) spray-coating, (e) adhesion of powders of a coating material to a substrate by using a thermosetting adhesive, and (f) adhesion of powders of a coating material to a substrate by using a thermoplastic adhesive. In some other embodiments, the polymeric substrate may be coated during polymerization by use of a suspension polymerizing formulation including a reactant having thermodynamic preferences to undergo phase separation from the bulk of a forming thermoset polymer and migrate towards a surface of a resulting catalytic polymer bead as well as to associate more strongly than the thermoset polymer with a transition metal compound. In other embodiments, combinations of the above may be used.

Without limiting the scope of the invention, in many embodiments a catalytic polymer bead is manufactured by using a coating method that avoids inflicting serious damage to a substrate material. In this context, (a) the avoidance of serious damage means that a packing of the catalytic polymer beads manifests a conductivity, after 300 hours, that is at least 80% of the conductivity of a packing of beads of the polymeric substrate material measured, after 300 hours under a set of comparable test conditions; and (b) the use of comparable test conditions means the use of a comparable surface coverage by beads of comparable U.S. mesh size in a packing used in a test cell, and the use of substantially the same closure stress, temperature, and type of test fluid during the tests.

### E. Geometrical and Physical Attributes of Catalytic Polymer Beads

While a coating of any thickness may be used, a coating that is as thin as possible within the practical constraints of a fabrication process is usually preferred. With a thinner coating, (a) a larger percentage of a transition metal compound is located at the outer surface of the coating and thus exposed to the external environment, improving the efficiency of its use; (b) the specific gravity of a catalytic polymer bead may remain in a range that is optimum for a subterranean application even if a coating material has a substantially higher specific gravity than a substrate; and (c) the mechanical properties of a catalytic polymer bead may be affected less adversely.

In a non-limiting example, a substrate bead possesses a specific gravity in the range of 1.00 to 1.11 which is far lower than the specific gravities of many transition metal compounds. For example, NiO has a specific gravity of around 6.7. The specific gravity of a catalytic polymer bead would increase rapidly with the coating thickness if a coating of a transition metal compound of much higher specific gravity were placed around a substrate.

In some embodiments, a catalytic polymer bead has a specific gravity in a range that is commonly considered to be “ultralightweight” by workers in the field of the invention (not exceeding 1.25). In some other embodiments, a catalytic polymer bead has a specific gravity not exceeding 1.15 so that it is nearly neutrally buoyant in many fracturing media. The use of a coating including a transition metal compound embedded in a polymeric material, which will often have a substantially lower specific gravity than a coating of the transition metal compound by itself, is an approach that may be utilized to both (a) keep the specific gravity of a catalytic polymer bead as low as possible (for example, not exceeding 1.25 or 1.15), and (b) reduce the variations in specific gravity among different catalytic polymer beads from a given batch of product arising from small differences in substrate particle size and/or coating thickness.

The specific gravity, D, of a catalytic polymer bead can be estimated in terms of the volume fractions and specific gravities of its substrate and coating components. If the volume fraction of the substrate is denoted by Vₛ so that the volume fraction of the coating equals V_{c}=(1−Vₛ), then D=Dₛ×Vₛ+D_{c}×V_{c} where Dₛ is the specific gravity of the substrate and D_{c} is the specific gravity of the coating. As a non-limiting example, if a substrate is a spherical bead of diameter d before a coating of thickness t is placed uniformly on it, the diameter of a coated bead will be (d+2t). Since the volume of a sphere is proportional to the third power of its diameter, V_{c}=[(d+2t)³−d³]/(d+2t)³=1−[d/(d+2t)]³. If a coating possessing a specific gravity of 2.0 (D_{c}=2.0) is placed at a thickness of 3 microns (t=0.003 mm) on a spherical substrate whose specific gravity is 1.054 (Dₛ=1.054), it can thus be calculated readily that a coated bead will have D=1.066 for a 14 U.S. mesh size (d=1.41 mm) substrate, D=1.074 for a 20 U.S. mesh size (d=0.84 mm) substrate, D=1.082 for a 30 U.S. mesh size (d=0.589 mm) substrate, D=1.093 for a 40 U.S. mesh size (d=0.42 mm) substrate, and D=1.144 for a 80 U.S. mesh size (d=0.177 mm) substrate. Consequently, in order to prepare spherical catalytic polymer beads of similar specific gravity D (such as beads having D values within ±0.02 of each other) from spherical substrates possessing Dₛ=1.054 and a broad particle size distribution, one may need to place a coating with D_{c}=2.0 at a thickness that decreases significantly with decreasing substrate diameter.

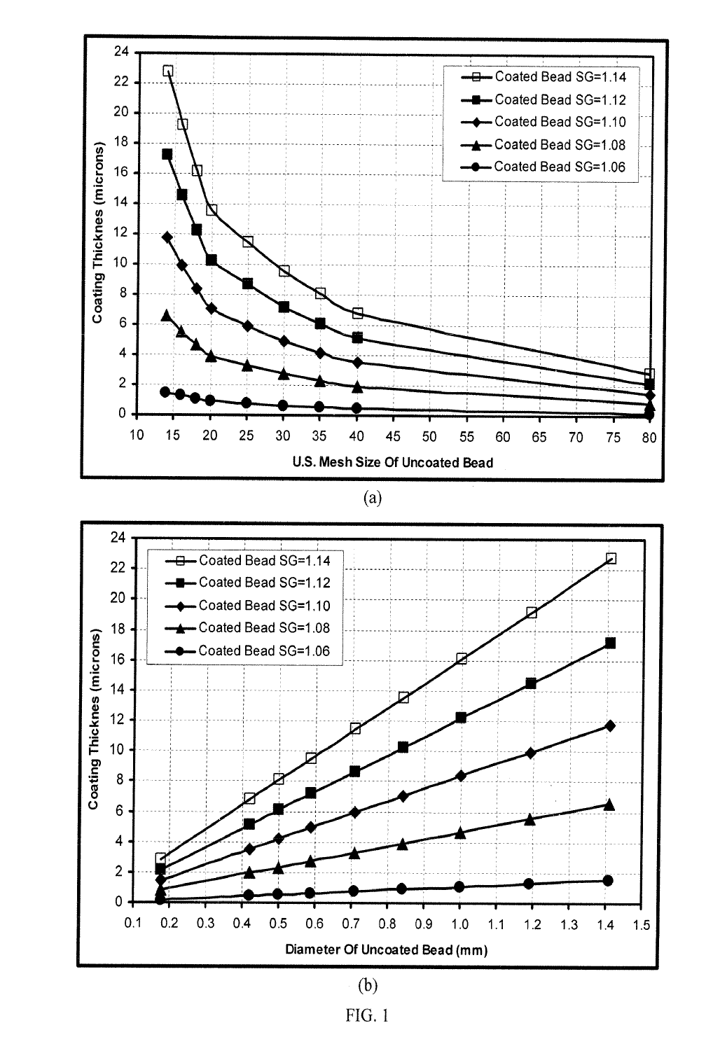

FIG. 1 shows the calculated thickness of a coating whose specific gravity (SG) is 2.0, when it is placed on a spherical substrate (uncoated bead) whose specific gravity is 1.054 at a sufficient thickness that the coated bead specific gravities attain the values shown in the curve labels, as a function of the U.S. mesh size (a) and the diameter (b) of the spherical substrate.

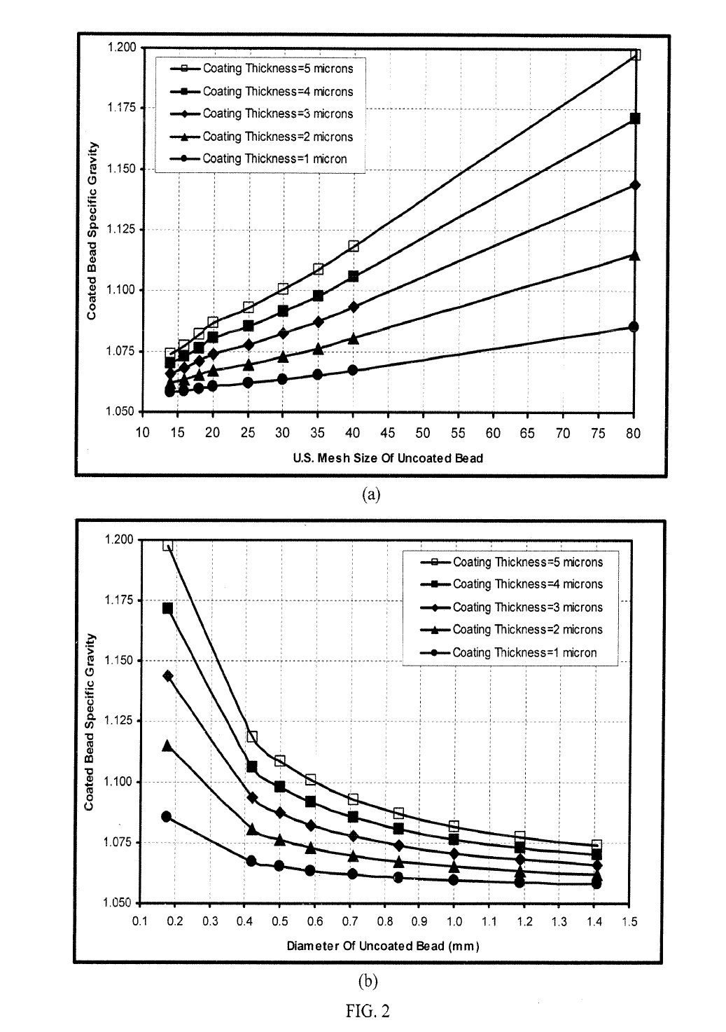

FIG. 2 shows the calculated specific gravity of a coated spherical bead obtained by placing a coating whose specific gravity (SG) is 2.0 on a spherical substrate (uncoated bead) whose specific gravity is 1.054 at the thicknesses shown in the curve labels, as a function of the U.S. mesh size (a) and the diameter (b) of the spherical substrate.

As a non-limiting example providing further clarification about the effects of the specific gravities of the polymeric substrate material and the coating material, consider embodiments of the invention where the targeted catalytic polymer bead specific gravity is 1.14, spherical substrate S1 has a specific gravity of 1.0, spherical substrate S2 has a specific gravity of 1.054, coating C1 has a specific gravity of 2.0, coating C2 has a specific gravity of 4.0, and the spherical substrates S1 and S2 are of the 20 U.S. mesh size (d=0.84 mm). The targeted specific gravity of 1.14 is then reached at the following coating thicknesses: 21.65 microns for C1 on S1, 6.745 microns for C2 on S1, 13.55 microns for C1 on S2, and 4.17 microns for C2 on S2.

While non-limiting theoretical examples where a coating is placed at a uniform thickness around a substrate were discussed above to simplify the teaching of the invention, the thickness of a coating placed on a given substrate bead in a physical example may vary. The placement of a coating with a variable thickness on a substrate is within the scope of the invention. As non-limiting examples, a coating thickness may vary between 0.1 microns and 0.7 microns on a substrate bead, and between 0.5 microns and 1.5 microns on another substrate bead. As another non-limiting example, a discontinuous coating may be placed on a substrate bead, with a coating thickness varying between 0 microns (“bald spots” not containing any coating) and 1.5 microns.

The catalytic polymer beads may possess any desired shape or any desired mixture of shapes. Any preferred shape or mixture of shapes may be chosen to optimize catalytic polymer bead utilization in any given application. In many non-limiting embodiments of the invention, the catalytic polymer beads are substantially spherical in shape; where a substantially spherical bead is defined as a bead having a roundness of at least 0.7 and a sphericity of at least 0.7, as measured by the use of a Krumbien/Sloss chart using the experimental procedure recommended in International Standard ISO 13503-2:2006, “Petroleum and Natural Gas Industries—Completion Fluids and Materials—Part 2: Measurement of Properties of Proppants Used in Hydraulic Fracturing and Gravel-Packing Operations” (2006), Section 7, for the purposes of this disclosure.

The various embodiments of the catalytic polymer beads described above should possess sufficient compressive strength or structural integrity to withstand the high closure stresses and temperatures of hydrocarbon reservoirs. In some embodiments, the catalytic polymer beads may have a crush resistance of greater than 40 MPa. In some other embodiments, the catalytic polymer beads may have a crush resistance of greater than 55 MPa. In yet some other embodiments, the catalytic polymer beads may have a crush resistance of greater than 70 MPa. In such embodiments, crush resistance may be determined according to International Standard ISO 13503-2:2006, “Petroleum and Natural Gas Industries—Completion Fluids and Materials—Part 2: Measurement of Properties of Proppants Used in Hydraulic Fracturing and Gravel-Packing Operations” (2006), Section 11.

### F. Use in Production of Natural Gas, Light Crude Oil, or Sequences or Mixtures Thereof

In some embodiments, the catalytic polymer bead may be used in a method for the in-situ production of natural gas. Such a method may include the steps of: (a) suspending a catalytic polymer bead in a fracturing medium, wherein the catalytic polymer bead is nearly neutrally buoyant in the fracturing medium; (b) introducing the suspension into a subterranean formation at sufficiently high rates and pressures that the formation fails and fractures to accept the suspension; and (c) collecting the natural gas generated by the subterranean formation. In implementations of this method, a catalytic polymer bead may accelerate the breakdown of hydrocarbon molecules present in the reservoir into hydrocarbon molecules of smaller molecular weight and eventually into natural gas over commercially acceptable time scales, thus producing new natural gas in “real time”.

For the purposes of this invention, a “nearly neutrally buoyant” catalytic polymer bead is defined as a catalytic polymer bead possessing a specific gravity that is very similar to the specific gravity of the fluid in which it is being transported. For example, catalytic polymer beads whose specific gravities may range from 1.00 to 1.15 are used in some non-limiting embodiments of the invention. Since such beads are nearly neutrally buoyant in water and in many other fluids used in fracturing operations, they can be transported readily into a fracture by means of a low-density fluid, including, but not limited to, a brine, salt water, an unviscosified water, a slickwater, fresh water, a liquid hydrocarbon, or a mixture thereof; or they can be used in a process incorporating a pre-slurried catalytic polymer bead concentrate foamed with a gas such as nitrogen (N₂) or carbon dioxide (CO₂) and pumped into a fracture; at a concentration that may result in their placement therein as a partial monolayer.

In some other embodiments, the catalytic polymer bead may be used in a method for the in-situ production of natural gas. Such a method may include the steps of: (a) suspending a catalytic polymer bead in a fracturing medium, wherein the catalytic polymer bead is nearly neutrally buoyant in the fracturing medium; (b) injecting a gas into a subterranean formation; (c) introducing the suspension into a subterranean formation at sufficiently high rates and pressures that the formation fails and fractures to accept the suspension; and (d) collecting the natural gas generated by the subterranean formation. An injected gas must be substantially free of oxygen since oxygen may poison a transition metal catalyst and thus reduce its catalytic activity. In some embodiments, such gas may be (a) reactive, and thus potentially able to participate in chemical reactions that lead to catalytic natural gas production; (b) unreactive, so that its main influence involves modifying the physical environment, for example thus rendering various dynamic processes, such as the transport of reactants, intermediates, and products, more favorable for efficient natural gas production; or (c) a mixture thereof. In this context, the term “substantially free of oxygen” is defined as “containing no more than 100 parts per million (ppm) of oxygen”. For example, an injected gas that is designated as being substantially free of oxygen based on this definition may contain 100 ppm of oxygen, 10 ppm of oxygen, or no (0 ppm) oxygen, in some of the non-limiting embodiments of the invention.

In yet some other embodiments, the catalytic polymer bead may be used in a method for the in-situ production of natural gas. Such a method may include the steps of: (a) suspending a catalytic polymer bead in a fracturing medium, wherein the catalytic polymer bead is nearly neutrally buoyant in the fracturing medium, wherein the fracturing medium includes a gas; (b) introducing the suspension into a subterranean formation at sufficiently high rates and pressures that the formation fails and fractures to accept the suspension; and (c) collecting the natural gas generated by the subterranean formation. Such gas, included in the fracturing medium, must be substantially free of oxygen since oxygen may poison a transition metal catalyst and thus reduce its catalytic activity. In some embodiments, such gas may be (a) reactive, and thus potentially able to participate in chemical reactions that lead to catalytic natural gas production; (b) unreactive, so that its main influence involves modifying the physical environment, for example thus rendering various dynamic processes, such as the transport of reactants, intermediates, and products, more favorable for efficient natural gas production; or (c) a mixture thereof.

The method may further include the emplacement of a catalytic polymer bead within a fracture network in a subterranean formation in a packed mass or a partial monolayer of particles; propping open the fracture network; and thereby allowing produced gases, liquids, or a mixture thereof, to flow towards the wellbore.

Natural gas whose production is being stimulated by a catalytic polymer bead may hence include natural gas that was formed over geological time scales, natural gas that was formed and/or that is being formed at an accelerated rate as a result of the catalytic action of the catalytic polymer bead, or a mixture thereof. The catalytic polymer beads of the invention hence differ dramatically from conventional proppants which stimulate the extraction of natural gas already present in a hydrocarbon reservoir as a result of geological processes that have taken place in the past (usually over millions of years) but do not catalyze the formation of new natural gas.

In some non-limiting embodiments of the invention, a catalytic coating placed on a substrate remains substantially intact in a subterranean environment of a hydrocarbon reservoir so that catalytic processes resulting in the production of natural gas occur mainly on the surfaces of the catalytic polymer beads. In some other non-limiting embodiments, the adhesion between a substrate and its catalytic coating is barely strong enough (and/or the coating material itself is barely strong and durable enough) for the coating to remain substantially intact during transport to a subterranean environment where it becomes partially or completely detached over time (and/or disintegrates over time) upon exposure to the environment, thus potentially increasing the exposed catalyst surface area available to provide catalytic activity. For the purposes of this disclosure, a coating is considered to have remained “substantially intact” if it has retained at least 80% of its thickness and at least 80% of the covered percentage of the surface area of a catalytical polymer bead. Many analytical techniques are available for evaluating the extent to which a coating may be affected by transport to a subterranean environment. If it is possible to recover some of the catalytic polymer beads from the subterranean environment, such recovered beads can be compared with unused beads to assess the effect, if any, of the transport process to the coatings on the beads. However, it is usually more feasible and cost-effective from a practical standpoint to compare unused beads with beads that have been subjected under controlled laboratory conditions to environments (such as immersion in the carrier fluid of interest) and physical conditions (such as temperature, pressure, and flow rate) similar to those that are likely to be encountered during transport. The most useful analytical technique or combination of techniques to use in such comparisons depend on the details of the composition and the thickness of the coating. The analytical techniques available for making such comparisons include, but are not limited to, optical microscopy, scanning electron microscopy, transmission electron microscopy, Auger electron spectroscopy (AES), x-ray photoelectron spectroscopy, time-of-flight secondary ion mass spectrometry (TOF-SIMS), dynamic secondary ion mass spectrometry (D-SIMS), energy dispersive analysis (EDA), electron energy loss spectroscopy (EELS), gas chromatography coupled with mass spectroscopy (GC-MS), surface topography analysis, and combinations or sequences thereof.

A non-limiting example of an alternative application is in the breaking down of a heavy crude oil in a hydrocarbon reservoir to produce a lighter crude oil from the reservoir. An advantage of the invention is, in fact, that it may allow the selective extraction of either crude oil that is lighter than the hydrocarbons that were present initially in a hydrocarbon reservoir, or natural gas, or a combination or sequence of lighter crude oil and natural gas, from the same fracture in a given hydrocarbon reservoir. (When applied to a hydrocarbon, the term “lighter” is defined, in this disclosure, to mean “having a lower average molecular weight”.) Such versatility of production from a given subterranean formation is enabled by the possibilities of (a) optimizing the catalytic polymer bead composition and/or the many other compositional and/or processing parameters that can be varied during the use of the beads to produce a targeted product or mixture of products from the formation, and/or (b) using different catalytic polymer bead compositions and/or other compositional and/or processing parameters at different stages of production. The “many other compositional and/or processing parameters that can be varied”, referred to in the preceding sentence, are familiar to workers of ordinary skill in the field of the invention. They include, but are not limited to, the concentration of catalytic polymer beads suspended in a fracturing medium, the use of blends of catalytic polymer beads possessing different coatings and hence manifesting different catalytic activities in a given subterranean environment, the composition of a fracturing medium, and the rate and pressure at which the suspension is introduced into a formation.

Catalytic polymer beads whose specific gravities may range from 1.00 to 1.15 are used in some non-limiting embodiments of the invention. Since such beads are nearly neutrally buoyant in water and in many other fluids used in fracturing operations, they can be transported readily into a fracture by means of a low-density fluid, including, but not limited to, a brine, salt water, an unviscosified water, a slickwater, fresh water, a liquid hydrocarbon, or a mixture thereof; or they can be used in a process incorporating a pre-slurried catalytic polymer bead concentrate foamed with a gas such as nitrogen (N₂) or carbon dioxide (CO₂) and pumped into a fracture; at a concentration that may result in their placement therein as a partial monolayer.

1. A catalytic polymer bead comprising a thermoset polymer substrate and a coating comprising a transition metal compound, wherein said catalytic polymer bead possesses a specific gravity ranging from 1.00 to 1.25.

2. The catalytic polymer bead of claim 1, wherein said catalytic polymer bead is substantially spherical in shape; where a substantially spherical bead is defined as a bead having a roundness of at least 0.7 and a sphericity of at least 0.7, as measured by the use of a Krumbien/Sloss chart.

3. The catalytic polymer bead of claim 1, wherein said substrate possesses a specific gravity in the range of 1.00 to 1.11.

4. The catalytic polymer bead of claim 1, wherein said thermoset polymer substrate is non-porous.

5. The catalytic polymer bead of claim 1, wherein said thermoset polymer substrate further comprises nanofiller particles possessing a length that is less than 500 nanometers in at least one principal axis direction dispersed throughout said thermoset polymer substrate.

6. The catalytic polymer bead of claim 5, wherein said nanofiller comprises carbon black.

7. The catalytic polymer bead of claim 1, wherein said substrate is a terpolymer of styrene, ethyl vinylbenzene, and divinylbenzene.

8. The catalytic polymer bead of claim 1, wherein said substrate further comprises an impact modifier material.

9. The catalytic polymer bead of claim 1, wherein said substrate further comprises a dispersed filler, a coating, or a combination thereof, wherein said dispersed filler is selected from the group consisting of a ferroelectric material, a giant magnetostrictive material, or mixtures thereof.

10. The catalytic polymer bead of claim 1, wherein said transition metal compound comprises nickel, iron, cobalt, titanium, vanadium, chromium, zirconium, tungsten, rhenium, ruthenium, molybdenum, hafnium, tantalum, osmium, iridium, platinum, palladium, or a mixture thereof.

11. The catalytic polymer bead of claim 1, wherein said transition metal compound comprises a metal nanocluster, metal halide, metal oxide, metal hydride, metal porphyrin, metal ester, metal phosphine, metal aminophosphine, metallocene, Ziegler-Nitta catalyst, Grubbs catalyst, Schrock catalyst, or mixture thereof.

12. The catalytic polymer bead of claim 1, wherein said transition metal compound is placed as a coating on said substrate, embedded in a polymeric coating that is placed on said substrate, or a combination thereof.

13. The polymeric coating of claim 12, wherein said coating is selected from the group consisting of an epoxy, an epoxy vinyl ester, a polyester, an acrylic, a phenolic, an alkyd resin, a melamine-based resin, a furfuryl alcohol resin, a polyacetal, a polyurethane, a polyurea, a polyimide, a polyxylylene, a silicone, a fluoropolymer, a copolymer thereof, or a combination thereof.

14. The catalytic polymer bead of claim 1, wherein a transition metal compound in the form of a powder in which more than 50% of the particles have dimensions of less than 400 nanometers in all three principal axis directions is used as a precursor for said coating.

15. The catalytic polymer bead of claim 1, wherein a transition metal compound in the form of a powder in which more than 50% of the particles have dimensions of less than 100 nanometers in all three principal axis directions is used as a precursor for said coating.

16. The catalytic polymer bead of claim 1, wherein a transition metal compound in the form of a powder in which more than 50% of the particles have dimensions of less than 25 nanometers in all three principal axis directions is used as a precursor for said coating.

17. A method for the in-situ production of natural gas, comprising the steps of:
suspending a catalytic polymer bead according to claim 1 in a fracturing medium, wherein said catalytic polymer bead is nearly neutrally buoyant in said fracturing medium;
introducing said suspension into a formation at sufficiently high rates and pressures that the formation fails and fractures to accept said suspension; and
collecting the natural gas generated by the subterranean formation.

18. The method of claim 17, further comprising injecting a gas into said subterranean formation, said gas being substantially free of oxygen.

19. The method of claim 18, wherein said gas may be a reactive gas, an unreactive gas, or a mixture thereof.

20. The method of claim 17, wherein said fracturing medium comprises a gas that is substantially free of oxygen.

21. The method of claim 17, wherein said catalytic polymer bead is emplaced within a fracture network in said subterranean formation in a packed mass or a partial monolayer of particles; propping open the fracture network; and thereby allowing produced gases, liquids, or a mixture thereof, to flow towards the wellbore.

22. The method of claim 17, wherein said natural gas may comprise gas that was formed over geological time scales, gas that was formed as a result of the action of said catalytic polymer bead after its placement in said subterranean formation, gas that is being formed as a result of the action of said catalytic polymer bead, or a mixture thereof.

23. The method of claim 17, wherein said fracturing medium comprises a low-density fluid.

24. The method of claim 23, wherein said low-density fluid is selected from the group consisting of a brine, salt water, an unviscosified water, a slickwater, fresh water, a liquid hydrocarbon, or a mixture thereof.

25. The method of claim 17, wherein said catalytic polymer bead is incorporated into a pre-slurried concentrate foamed with a gas and pumped into the fracture.

26. The method of claim 25, wherein said gas is selected from the group consisting of nitrogen, carbon dioxide, or a mixture thereof.

27. The method of claim 25, wherein said gas may be a reactive gas, an unreactive gas, or a mixture thereof.

28. A method for the in-situ production of crude oil, comprising the steps of:
suspending a catalytic polymer bead according to claim 1 in a fracturing medium, wherein said catalytic polymer bead is nearly neutrally buoyant in said fracturing medium;
introducing said suspension into a formation at sufficiently high rates and pressures that the formation fails and fractures to accept said suspension; and
collecting the crude oil generated by the subterranean formation.

29. The method of claim 28, wherein said produced crude oil is lighter than the hydrocarbons that were present initially in said formation.

30. A method for the in-situ production of natural gas, crude oil, or mixtures or sequences thereof, comprising the steps of:
suspending a catalytic polymer bead according to claim 1 in a fracturing medium, wherein said catalytic polymer bead is nearly neutrally buoyant in said fracturing medium;
introducing said suspension into a formation at sufficiently high rates and pressures that the formation fails and fractures to accept said suspension; and
collecting the natural gas, crude oil, or mixtures or sequences thereof, generated by the subterranean formation.

31. The method of claim 30, wherein a selective extraction of a crude oil, a natural gas, or a combination or sequence thereof, from the same fracture in a given hydrocarbon reservoir, is achieved by optimizing a catalytic polymer bead composition, a composition of a blend of catalytic polymer beads of differing catalytic activities, a concentration of a catalytic polymer bead suspended in a fracturing medium, a composition of a fracturing medium, the rate and pressure at which a suspension is introduced into a formation, the use of multiple production stages wherein a subsequent stage may differ from the stage preceding it by a variation of any one or combination of the aforementioned variables, or a combination thereof.
